(19) United States
(12) Patent Application Publication
(10) Pub. No.: US 2026/0170613 A1
(43) Pub. Date: Jun. 18, 2026

(54) IMAGE PROCESSING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Kohei OGI, Kanagawa (JP)

(21) Appl. No.: 19/417,446

(22) Filed: Dec. 12, 2025

(30) Foreign Application Priority Data
Dec. 16, 2024 (JP) 2024-220251

(51) Int. Cl. G06T 5/50; G06T 5/70; G06T 7/00

(52) U.S. Cl. CPC G06T 5/50; G06T 5/70; G06T 7/0002; G06T 2207/30168

(57) ABSTRACT

There is provided with an image processing apparatus. A first generating unit generates a second image having a higher image quality than a first image by performing first image-quality enhancement processing. A second generating unit generates a third image having a higher image quality than the first image by performing second image-quality enhancement processing that is different from the first image-quality enhancement processing and has a generation condition specified as text. A display controlling unit performs display control for displaying at least one of the second image and the third image.

### BACKGROUND

### Field of the Technology

The present disclosure relates to an image processing apparatus, an image processing method, and a non-transitory computer-readable storage medium.

### Description of the Related Art

Conventionally, in cameras and PC image editing software or the like, raw image information (RAW image) captured by an image sensor is subjected to development processing such as image-quality enhancement processing based on debayer processing or noise removal, optical distortion correction, and image optimization. It is known that image defects such as artifacts, moiré, and zipper noise occur in specific image regions as a result of development processing that includes debayer processing or noise removal being performed. Heretofore, if a user desires to correct such image defects, the user needs to change the development processing parameter settings and perform development once again from scratch. However, depending on the neural network model or the rule-based method such as noise removal or debayer processing used in the development process, there are cases in which it is difficult to remove or reduce the image defects that the user desires to improve.

For example, in Japanese Patent Laid-Open No. 2021-86272, a high-quality image is provided to a user by using a single neural network model to generate a plurality of images to which different image processing effects are applied.

However, due to various factors such as neural network scale, characteristics, and compatibility with the input image, the method disclosed in Japanese Patent Laid-Open No. 2021-86272 may have little effect on certain image defects even if the image processing effect or internal parameters are changed. In such cases, it is difficult to generate images in which the image defects are removed or reduced.

### SUMMARY

According to one embodiment of the present disclosure, an image processing apparatus that provides display of a quality-enhanced image desired by a user is provided.

According to one embodiment of the present disclosure, an image processing apparatus comprises: a first generating unit configured to generate a second image having a higher image quality than a first image by performing first image-quality enhancement processing; a second generating unit configured to generate a third image having a higher image quality than the first image by performing second image-quality enhancement processing that is different from the first image-quality enhancement processing and has a generation condition specified as text; and a display controlling unit configured to perform display control for displaying at least one of the second image and the third image.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating an example of a hardware configuration of an image processing apparatus.

FIG. 2 is a block diagram illustrating an example of a functional configuration of the image processing apparatus.

FIG. 3 is a flowchart illustrating an example of processing by the image processing apparatus according to embodiment 1.

FIGS. 4A and 4B are diagrams each illustrating an example of display based on display control according to embodiment 1.

FIG. 5 is a flowchart illustrating an example of processing by the image processing apparatus according to embodiment 2.

FIG. 6 is a flowchart illustrating an example of processing by the image processing apparatus according to embodiment 3.

FIG. 7 is a diagram illustrating an example of display based on display control according to embodiment 3.

FIG. 8 is a flowchart illustrating an example of notification processing according to embodiment 4.

FIG. 9 is a diagram illustrating an example of display of a notification according to embodiment 4.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Embodiment 1

### <Hardware Configuration>

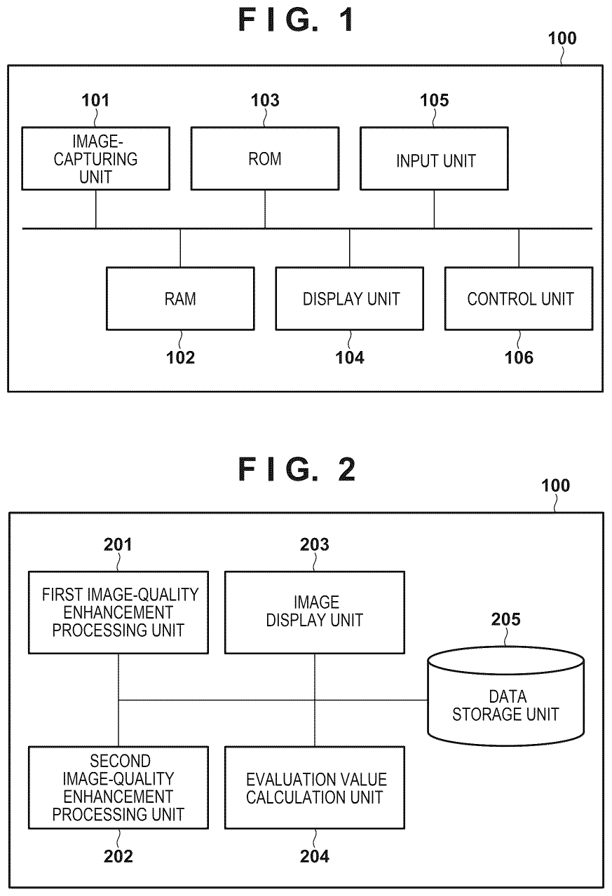

FIG. 1 is a block diagram illustrating an example of a hardware configuration of an image processing apparatus according to the present embodiment. An image processing apparatus 100 according to the present embodiment includes an image-capturing unit 101, a RAM 102, a ROM 103, a display unit 104, an input unit 105, and a control unit 106. Note that the pieces of hardware included in the image processing apparatus 100 are configured to be capable of communicating with one another, and are connected to one another via a bus or the like. Furthermore, while the image processing apparatus 100 according to the present embodiment may have a configuration in which the image-capturing unit 101 is not included, description will be provided in the following assuming that a configuration in which the image-capturing unit 101 is included is adopted. Furthermore, the image processing apparatus 100 may be an apparatus that is built into an image-capturing apparatus such as a digital camera or a digital video camera, or an apparatus that is built into a personal computer, a mobile phone, a drive recorder, a robot, a drone, or the like provided with a camera function. Furthermore, the image processing apparatus 100 may be an apparatus that is built into any electronic device such as those mentioned above in which image-quality enhancement processing is performed, or may be a personal computer, a server device, or the like that executes different types of processing by being connected to such electronic devices.

The image-capturing unit 101 acquires a captured image. The image-capturing unit 101 according to the present embodiment includes an image-capturing lens, an image sensor, an A/D converter, an aperture control device, and a focus control device. The image-capturing lens includes a fixed lens, a zoom lens, a focus lens, an aperture, and an aperture motor. The image sensor includes a CCD, a CMOS, or the like that converts an optical image of a subject into electrical signals. The A/D converter converts analog signals into digital signals.

The image-capturing unit 101 converts the subject image formed on the image forming surface of the image sensor by the image-capturing lens into electrical signals, applies signal processing for A/D conversion processing on the electric signals using the A/D converter, and outputs the resulting signals to the RAM 102 as image data. The aperture control device controls the aperture of the image-capturing lens by controlling the operation of the aperture motor and changing the opening diameter of the aperture. The focus control device controls the focus condition of the image-capturing lens by controlling the operation of a focus motor based on the phase difference between a pair of focus detection signals obtained from the image sensor and driving the focus lens. Note that the processing and mechanism of generation of a captured image by the image-capturing unit 101 are not limited to those mentioned above, and those used in conventional image-capturing processing can be adopted, as appropriate.

The RAM 102 stores image data obtained by the image-capturing unit 101, and image data to be displayed on the display unit 104. The RAM 102 according to the present embodiment has a storage capacity that is sufficient for storing a predetermined number of still images and moving image(s) of a predetermined duration. Furthermore, here, the RAM 102 also functions as an image display memory (video memory), and supplies display image data to the display unit 104.

The ROM 103 is a storage device such as a magnetic storage device or a semiconductor memory, and stores therein one or more programs loaded based on the operation of the control unit 106, data that needs to be stored over a long period of time, etc.

The display unit 104 is formed from a liquid-crystal display or the like, and can display, to a user, various types of data and processing results.

The input unit 105 is formed from input devices such as one or more switches, buttons, and/or keys, or a keyboard, and receives input from the user. Furthermore, the input unit 105 may be configured to also function as the display unit 104, in which case the input unit 105 is a touch panel or the like. Input performed via the input devices is detected by the control unit 106 via the bus, and the control unit 106 controls units in order to realize an operation corresponding to the input.

The control unit 106 is formed from one or more central processing units (CPUs). The control unit 106 realizes the functions of the image processing apparatus 100 by performing, inter alia, the execution of the programs stored in the ROM 103. Furthermore, the control unit 106 controls the image-capturing unit 101 to perform aperture control, focus control, and exposure control. For example, the control unit 106 executes automatic exposure (AE) processing for automatically determining an exposure condition (shutter speed, accumulation time, f-number, or sensitivity) based on information regarding subject luminance in image data obtained by the image-capturing unit 101. Furthermore, by using a subject-region detection result, the control unit 106 can automatically set the focus detection region and thereby realize a function for performing tracking AF processing on a desired subject region. Furthermore, the control unit 106 can also perform AE processing based on luminance information of the focus detection region and perform image processing (e.g., gamma correction processing, automatic white balance (AWB) adjustment processing, or the like) based on pixel values in the focus detection region. The control unit 106 also performs display control by controlling the input unit 105.

The image processing apparatus 100 according to the present embodiment performs image-quality enhancement processing. In particular, the image processing apparatus 100 according to the present embodiment is capable of using an image (hereinafter “degraded image”) including degradation in image quality as a processing-target image and performing processing for enhancing the image quality of the processing-target image. In the following, degradation in image quality, etc., that are removed by image-quality enhancement processing may be referred to as image defects.

In the following, description will be provided assuming that the image processing apparatus 100 according to the present embodiment includes the image-capturing unit 101, and performs image-quality enhancement processing using images acquired by the image-capturing unit 101 as processing-target images. However, images to be processed by the image processing apparatus 100 are not limited to those acquired by the image-capturing unit 101, and may be images stored in a storage device, images acquired via wireless communication, or the like. Furthermore, the image-capturing unit 101 does not necessarily have to be included in the image processing apparatus 100, in which case images acquired by an image-capturing apparatus that is external to the image processing apparatus 100 may be used as processing-target images.

The image processing apparatus 100 according to the present embodiment generates a first image and a second image obtained by enhancing the image quality of a processing-target image respectively using first image-quality enhancement processing and second image-quality enhancement processing, which is different from the first image-quality enhancement processing. FIG. 2 is a block diagram illustrating an example of a functional configuration of the image processing apparatus 100 according to the present embodiment. The image processing apparatus 100 illustrated in FIG. 2 includes a first image-quality enhancement processing unit (first processing unit) 201 a second image-quality enhancement processing unit (second processing unit) 202, an image display unit 203, an evaluation value calculation unit 204, and a data storage unit 205.

The first processing unit 201 performs the first image-quality enhancement processing on the processing-target image. The first image-quality enhancement processing according to the present embodiment is processing that can generate a compressed image (JPG, PNG, or the like) that is a first quality-enhanced image from the input image (RAW image). For example, as the first image-quality enhancement processing, noise removal, debayer processing, aberration correction, or the like can be used. In the present embodiment, description is provided in the following assuming that the first image-quality enhancement processing is such processing for correcting the input image.

The second processing unit 202 performs the second image-quality enhancement processing on the processing-target image. The second image-quality enhancement processing according to the present embodiment is processing that can, by using generative AI such as a GAN or a diffusion model, generate a new compressed image (JPG, PNG, or the like) that is a quality-enhanced image from the input image (compressed image (JPG, PNG, or the like)). In the following, in comparison with image-quality enhancement processing using generative AI, image-quality enhancement processing in which generative AI is not used may be referred to as “regular image-quality enhancement processing”. In the present embodiment, description is provided in the following assuming that the second image-quality enhancement processing is such processing in which generative AI is used and an image is generated without correcting the input image.

The image display unit 203 performs processing for displaying the input image or a quality-enhanced image on the display unit 104, processing for switching displayed images, or the like.

The evaluation value calculation unit 204 calculates a later-described evaluation value (SSIM, PSNR, or the like) by using the input image and a quality-enhanced image, or by using only a quality-enhanced image.

The data storage unit 205 holds images. For example, the data storage unit 205 can hold images before and after image-quality enhancement processing.

Here, description will be provided first of an example of image-quality enhancement processing performed by the second processing unit 202 according to the present embodiment, in which generative AI (e.g., diffusion model) is used. In diffusion-model-based image generation processing, a diffusion process in which noise is added to the input image and a reverse diffusion processing in which noise is removed are executed. In the reverse diffusion processing, an image is generated based on training data, and a generation condition such as the input image, text, or color tone. Note that, while information about image defects that were present in the image before processing may be lost due to noise being added temporarily in the diffusion process, the possibility of image defects being actively reproduced during generation is low because image defects are basically not included in a region in the vicinity of an image-defect portion and the training data referred to in the reverse diffusion processing.

The generation condition according to the present embodiment may be information that is input as text or information that is input in the form of an image, and is not particularly limited as long as the generation condition is information that is input when an image is generated by generative AI.

Described in more detail, the second processing unit 202 according to the present embodiment can perform image-quality enhancement processing using a technique called “Inpaint”. The Inpaint technique is a technique in which the input image and a mask image, in which a region in the input image from which image defects are to be removed is indicated by a mask, are input to generative AI, whereby image generation is performed only for the unmasked region. The color tone, edge information, etc., of the masked region are used when the unmasked region is generated; thus, image-quality enhancement processing in which continuous patterns, color tones, or the like are reproduced can be executed, and inconsistency between the inside and the outside of the masked region in the generated image can be reduced. In addition, because a generation condition can be provided to a diffusion model, an image can be generated while preserving structural information such as patterns and shapes present only in the unmasked region by providing edge information of the unmasked region as a generation condition. The second processing unit 202 can execute such image-quality enhancement processing, in which a diffusion model is used.

Furthermore, description will be provided of the differences between the first image-quality enhancement processing executed by the first processing unit 201 and the second image-quality enhancement processing (here, image-quality enhancement processing using generative AI) executed by the second processing unit 202.

Here, in the generation of a quality-enhanced image, no generation condition is provided in the first image-quality enhancement processing, whereas a generation condition is provided in the second image-quality enhancement processing. By providing a generation condition in the image-quality enhancement processing using generative AI according to the present embodiment, a quality-enhanced image can be generated while taking into consideration information such as text, color tone, or edges provided separately from the input image and parameter settings.

Three other differences between the first image-quality enhancement processing and the second image-quality enhancement processing will be described.

The first difference is that, in comparison with the image-quality enhancement processing using generative AI, the regular image-quality enhancement processing is less likely to affect structural information in the input image. For example, structural information according to the present embodiment refers to object shape, color tone, or pattern, or a person's face outline or hairstyle, etc. Because an image is generated from scratch by generative AI in the second image-quality enhancement processing according to the present embodiment, a difference in object structural information may be observed especially in an image region generated by generative AI.

The second difference is the difference in input image size. In the regular image-quality enhancement processing, the input image size corresponds to patch size. The patch size refers to an image size corresponding to a single unit when an image is divided into processable units (because a large image cannot be processed at once, for example). On the other hand, in the generative-AI-based image-quality enhancement processing according to the present embodiment, a region larger than the patch size also including the vicinity of the patch is used. This is because information about such a region in the vicinity is necessary to some extent when referring to information of the vicinity in the process of recreating an image-defect portion.

The third difference is that the regular image-quality enhancement processing is less likely to produce hallucinations (e.g., false details, artifacts) than the generative-AI-based image-quality enhancement processing. A hallucination according to the present embodiment refers to a phenomenon in which false, unfounded information is generated, one example of which being a case in which a person or object that was not present in the original image is generated. In such a manner, the first image-quality enhancement processing according to the present embodiment is processing in which hallucinations (e.g., false details, artifacts) are less frequently observed after processing compared to the second image-quality enhancement processing.

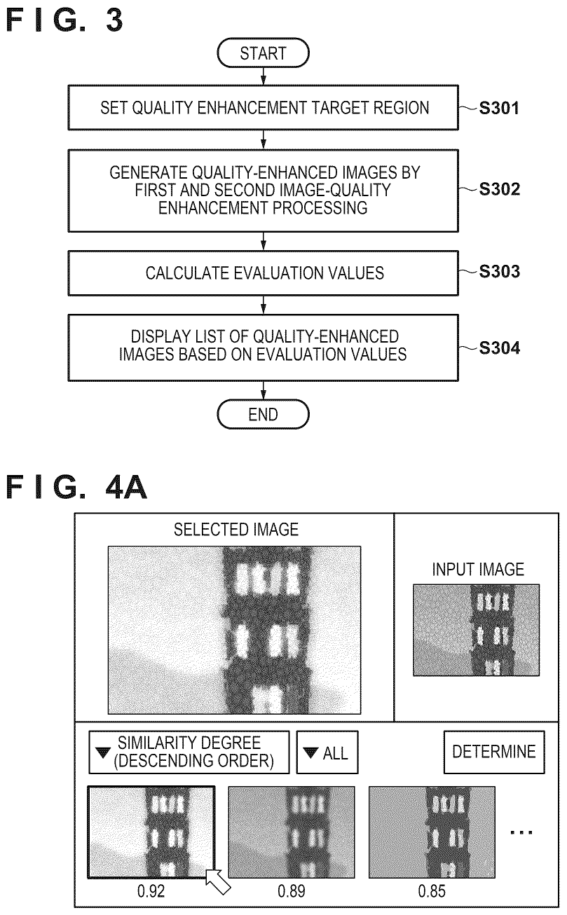

FIG. 3 is a flowchart illustrating an example of the image processing executed by the image processing apparatus 100 according to the present embodiment. For example, the processing illustrated in FIG. 3 is started if a processing-target input image is input (for example, if the user starts capturing an image, the processing is started using the captured image as the input image), and the different types of processing are executed by the control unit 106.

In step S301, the control unit 106 sets, in regard to the input image, a partial region in which image defects such as noise, line fading, artifacts, moiré, or zipper noise are to be corrected or reduced. Here, for example, the control unit 106 may set the partial region based on user input, or may set the partial region based on the input image. For example, the control unit 106 can extract one or more candidate regions from the input image using a predetermined detection algorithm, and set the processing-target partial region from among the extracted candidate regions based on value magnitude, region size, or the like. Note that, while description will be provided in the following assuming that processing is performed on a partial region, a configuration may be adopted such that image-quality enhancement processing is performed on the entire input image. In the following, the term “partial region” refers to a processing-target partial region that is set in such a manner, and the term “partial image” refers to an image within such a partial region.

As one predetermined detection algorithm for the detection of candidate regions executed by the control unit 106, an algorithm for detecting zipper noise or artifacts will be described. Here, for example, the control unit 106 can detect edges in the image using a Sobel filter or the Canny method, and determine regions densely packed with pixels having values higher than or equal to a threshold as regions in which zipper noise or artifacts are observed. Furthermore, in a case in which the partial region is set based on user input, a configuration may be adopted such that, for example, the user inputs an area in the image to be set as the partial region, or a configuration may be adopted such that the user selects a candidate region to be set as the partial region from among candidate regions extracted by the control unit 106.

In step S302, the control unit 106 generates, as quality-enhanced images, a first image (first quality-enhanced image) and a second image (second quality-enhanced image) by respectively executing the first image-quality enhancement processing and the second image-quality enhancement processing on an image of the partial region. Here, a quality-enhanced image is an image obtained by combining, with the input image, a quality-enhanced partial image that has been generated by applying predetermined image-quality enhancement processing on a partial image. Furthermore, it is sufficient that one or more each of the first quality-enhanced image and the second quality-enhanced image be generated, and the number of images to be generated is not particularly limited. Here, it is assumed that the number of first quality-enhanced images and second quality-enhanced images to be generated can be set by the user in advance, and a plurality each of the first quality-enhanced image and the second quality-enhanced image are generated.

In step S303, the evaluation value calculation unit 204 calculates evaluation values of image-quality enhancement processing using the input image and at least one of the first quality-enhanced images and the second quality-enhanced images generated in step S302. The evaluation values here are evaluation values of quality-enhanced images for evaluating how small an image change that occurred in image-quality enhancement processing is, and, for example, evaluation values of the quality-enhanced images with respect to the input image, such as Structual SIMilarity (SSIM) (similarity degree), are used. SSIM is one evaluation metric for evaluating the degree of similarity in structural information between the input image and a quality-enhanced image. For example, the evaluation value calculation unit 204 can calculate SSIM using Formula (1) below. This SSIM is a value between 0 and 1; a value closer to 0 indicates a lower structural similarity between the input image and the quality-enhanced image, and a value closer to 1 indicates a higher structural similarity.

$$SSIM ( x , y ) = \frac{( 2 {μ}_{x} {μ}_{y} + {C}_{1} ) ( 2 {σ}_{xy} + {C}_{2} )}{( {μ}_{x}^{2} + {μ}_{y}^{2} + {C}_{1} ) ( {σ}_{x}^{2} + {σ}_{y}^{2} + {C}_{2} )} \qquad Formula ( 1 )$$

Here, the input image is represented as image x, and the quality-enhanced image is represented as image y. Furthermore, μₓ is the average pixel value of image x, μ_{y} is the average pixel value of image y, σₓ is the standard deviation of the pixel values in image x, and σ_{y} is the standard deviation of the pixel values in image y. Furthermore, Oxy is the covariance between x and y, and C₁ and C₂ are constants (particularly for stabilizing the output value when the denominator is small).

As evaluation values other than SSIM, peak signal-to-noise ratio (PSNR) for evaluating image quality, SIFT for evaluating the degree of similarity in structural information, similarly to SSIM, or the like can be used. For example, the evaluation value calculation unit 204 can calculate PSNR using Formula (2) below. PSNR according to the present embodiment is calculated as PSNR of the input image with respect to a quality-enhanced image; here, a larger PSNR indicates less image degradation, and a smaller PSNR indicates greater image degradation.

$$\begin{matrix}MSE + \frac{1}{N} {{\sum }^{N}}_{i = 1} {( {Y}_{i} - {\hat{Y}}_{i} )}^{2} \\ PSNR = 10 {log}_{10} \frac{{MAX}^{2}}{MSE}\end{matrix} \qquad Formula ( 2 )$$

Here, N is the number of pixels, Yᵢ is a pixel value of the quality-enhanced image, Ŷᵢ is a pixel value of the input image, and MAX is the maximum luminance value.

Furthermore, the evaluation values may be those as described above that are calculated using the input image and quality-enhanced images, or may be evaluation values that are calculated using only quality-enhanced images. As such evaluation values that are calculated using only quality-enhanced images, the contrast, noise level, object detection count, or the like may be used, and all evaluation metrics that are conventionally used in image processing and image recognition are applicable. If the entire image is set as the processing target in step S301, the evaluation values are calculated from the entire image.

In step S304, the image display unit 203 performs display control so as to display at least one of the first quality-enhanced images and the second quality-enhanced images, whereafter the processing in FIG. 3 ends. Here, the image display unit 203 performs display control of the first quality-enhanced images and the second quality-enhanced images based on the evaluation values calculated in step S303. For example, the image display unit 203 can display the first quality-enhanced images and the second quality-enhanced images in a display order based on the evaluation values.

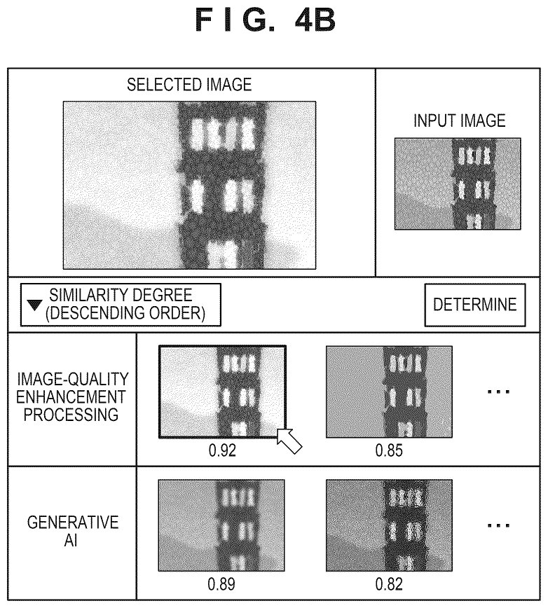

FIG. 4A is a diagram illustrating an example of a case in which similarity degrees are used as evaluation values, and the first quality-enhanced images and the second quality-enhanced images are displayed all together in descending order of similarity degrees without being distinguished from one another. This display method is suitable for selecting an image that is most similar to the input image from among all quality-enhanced images. Here, a sorting method in which display is performed starting from the left in descending order of evaluation values is illustrated as an example; however, display may be performed in a display order such as ascending order of evaluation values, the order of generation, or the order of image file size, and display may also be performed based on a sorting method that has been added or set as desired by the user. Furthermore, there is no need to perform sorting based on one type of evaluation value, and sorting may be performed using results obtained by combining multiple types of evaluation values. For example, by combining SSIM and noise level, the image display unit 203 can display images in the order of those having similar structural information and lower noise level. Furthermore, while the first quality-enhanced images and the second quality-enhanced images are displayed all together in the display example illustrated in FIG. 4A, a configuration may be adopted such that only the first quality-enhanced images (regular quality-enhanced images) are displayed, or only the second quality-enhanced images (quality-enhanced images generated using generative AI) are displayed. Such display processing allows the user to select a quality-enhanced image that does not differ much from the input image.

FIG. 4B is a diagram illustrating an example of a case in which similarity degrees are used as evaluation values, and the first quality-enhanced images and the second quality-enhanced images are distinguished from one another and displayed separately in descending order of similarity degrees. Here, a first display in which the first quality-enhanced images are displayed in descending order and a second display in which the second quality-enhanced images are displayed in descending order are displayed so as to be lined up. This display method is suitable for comparing the first quality-enhanced images (regular quality-enhanced images) and the second quality-enhanced images (quality-enhanced images generated using generative AI). Furthermore, such display enables a check to be performed in consideration of the trade-off relationship that the regular image-quality enhancement processing has limited image-defect-improving performance but does not change the input image much, and the image-quality enhancement processing using generative AI may significantly change the input image but can generate images without image defects. Such display processing allows the user to select a desired quality-enhanced image in consideration of the trade-off between the effects of the first image-quality enhancement processing and the second image-quality enhancement processing.

According to such a configuration, the first quality-enhanced images and the second quality-enhanced images can be generated, and display control for displaying at least one of the first quality-enhanced images and the second quality-enhanced images can be performed. In particular, display control of regular quality-enhanced images and quality-enhanced images generated using generative AI can be performed based on the evaluation values thereof. Accordingly, display allowing a user to select an image having an evaluation value that is close to the input image can be provided.

### Embodiment 2

In embodiment 1, the first image-quality enhancement processing and the second image-quality enhancement processing are each performed on the input image, and display control of the image group resulting from the processing is then performed. On the other hand, the image processing apparatus 100 according to embodiment 2 performs display of the first quality-enhanced images and display of the second quality-enhanced images in stages. The image processing apparatus 100 according to the present embodiment has the same configuration as that in embodiment 1 and can execute the same processing as that in embodiment 1; redundant description is thus omitted.

The image processing apparatus 100 according to the present embodiment performs display control so as to display the second quality-enhanced images if the evaluation values of the first quality-enhanced images do not satisfy a predetermined condition. For example, a configuration may be adopted such that the image processing apparatus 100 generates the first quality-enhanced images, and displays the first quality-enhanced images if the evaluation values of the first quality-enhanced images satisfy the predetermined condition. Here, the second quality-enhanced images are generated and displayed if the evaluation values of the first quality-enhanced images do not satisfy the predetermined condition. However, a configuration may also be adopted such that the first quality-enhanced images and the second quality-enhanced images are first generated as was the case in embodiment 1, and display control is performed so that the first quality-enhanced images are displayed if the evaluation values of the first quality-enhanced images satisfy the predetermined condition, and the second quality-enhanced images are otherwise displayed. Here, the display of the second quality-enhanced images in the case in which the evaluation values of the first quality-enhanced images do not satisfy the predetermined condition may be performed such that only the second quality-enhanced images are displayed or such that the second quality-enhanced images are displayed so as to be lined up with the display of the first quality-enhanced images.

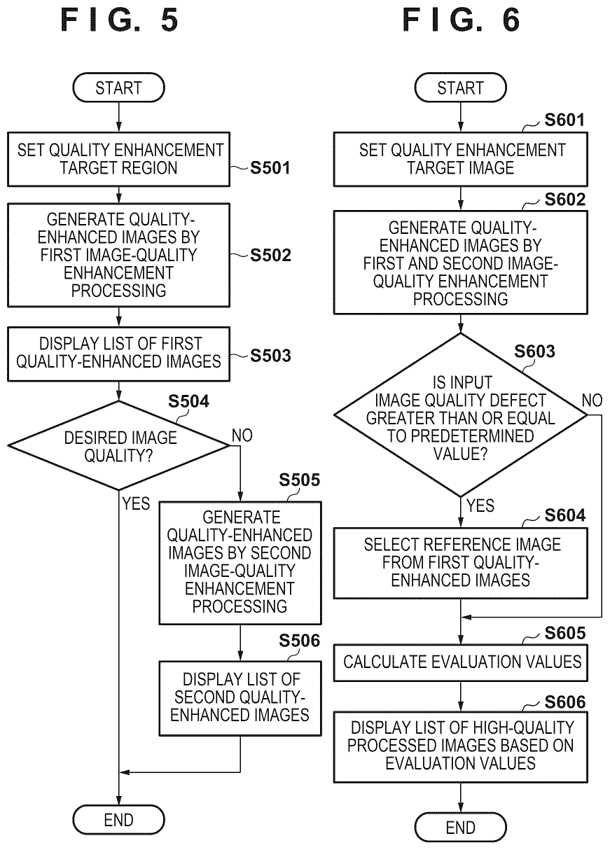

In the following, description is provided of an example of such image processing performed by the image processing apparatus 100. FIG. 5 is a flowchart illustrating an example of the image processing executed by the image processing apparatus 100 according to the present embodiment. For example, the processing illustrated in FIG. 5 is started if a processing-target input image is input (for example, if the user starts capturing an image, the processing is started using the captured image as the input image), and the different types of processing are executed by the control unit 106. The processing in step S501 is the same as that in step S301 in embodiment 1, and description thereof is thus omitted here.

In step S502 following step S501, the first processing unit 201 generates the first quality-enhanced images by executing the first image-quality enhancement processing on an image of the partial region.

In steps S503 to S506, the image processing apparatus 100 performs display control of the first quality-enhanced images and the second quality-enhanced images. Display control according to the present embodiment will be described in the following.

In step S503, the image display unit 203 displays the first quality-enhanced images generated in step S502 on the display unit 104. The display here is equivalent to that from which the display of the second quality-enhanced images in the processing described with reference to FIG. 4B of embodiment 1 is excluded.

In step S504, the evaluation value calculation unit 204 determines whether or not the first quality-enhanced images generated in step S502 (or displayed in step S503) satisfy the predetermined condition. Here, the evaluation value calculation unit 204 can use SSIM, PSNR, or the like as the evaluation values, for example, and determine that the first quality-enhanced images satisfy the predetermined condition if the evaluation values are higher than or equal to (or lower than or equal to) a desired threshold. Alternatively, for example, the evaluation value calculation unit 204 may display a UI (e.g., one or more buttons or the like) for receiving user input as to whether or not the displayed images are of the desired image quality in addition to the display of the first quality-enhanced images in step S503, and determine whether or not the predetermined condition is satisfied based on user input performed on the UI. The processing in FIG. 5 ends if it is determined that the first quality-enhanced images satisfy the predetermined condition; otherwise, processing advances to step S505.

In step S505, the second processing unit 202 generates the second quality-enhanced images by executing the second image-quality enhancement processing on the image of the partial region.

In step S506, the image display unit 203 displays the second quality-enhanced images generated in step S505 on the display unit 104, whereafter the processing in FIG. 5 ends. The display here may be equivalent to that from which the display of the first quality-enhanced images in the processing described with reference to FIG. 4B of embodiment 1 is excluded, or the first quality-enhanced images and the second quality-enhanced images may be displayed so as to be lined up, as was the case in FIG. 4B of embodiment 1.

According to such processing, display control can be performed so that the second quality-enhanced images are displayed if the first quality-enhanced images do not satisfy the predetermined condition. Accordingly, images desired by the user can be presented in a manner such that the user does not necessarily have to check all quality-enhanced images. Furthermore, user waiting time can also be reduced.

### Embodiment 3

In connection with the image processing apparatus 100 according to embodiment 1, description has been provided of processing in which the input image and quality-enhanced images are compared to calculate evaluation values of the quality-enhanced images, as an example of the calculation of evaluation values. The image processing apparatus 100 according to embodiment 3 uses a first quality-enhanced image in place of the input image in the calculation of evaluation values if pixel values of the input image (here, image-defect-related pixel values) satisfy a predetermined image-quality condition. The image processing apparatus 100 according to the present embodiment has the same configuration as that in embodiment 1 and can execute the same processing as that in embodiment 1; redundant description is thus omitted.

In the following, description is provided of an example of such image processing performed by the image processing apparatus 100. FIG. 6 is a flowchart illustrating an example of the image processing executed by the image processing apparatus 100 according to the present embodiment. For example, the processing illustrated in FIG. 6 is started if a processing-target input image is input (for example, if the user starts capturing an image, the processing is started using the captured image as the input image), and the different types of processing are executed by the control unit 106. The processing from step S601 to step S602, and the processing in step S606 are respectively the same as the processing from step S301 to step S302, and the processing in step S304 in embodiment 1, and description thereof is thus omitted here.

In step S603 following step S602, the evaluation value calculation unit 204 determines whether or not the pixel values of the input image satisfy a predetermined image-quality condition. Processing advances to step S604 if the pixel values of the input image satisfy the predetermined image-quality condition; otherwise, processing advances to step S605. Here, based on pixel values of the input image, the evaluation value calculation unit 204 can determine whether or not an image defect quantity in the input image is greater than or equal to an amount (threshold) satisfying the predetermined image-quality condition. For example, the evaluation value calculation unit 204 may use noise level as the image defect quantity and set, as the noise level, a difference between the original input image and a filtered image obtained by performing basic noise removal using a Gaussian filter, the standard deviation of luminance values in the input image, or the like, and determine that the predetermined image-quality condition is satisfied if the noise level is greater than or equal to a predetermined value. Alternatively, for example, blur may be used as the image defect quantity and the determination of whether or not the predetermined image-quality condition is satisfied may be performed based on edge strength generated by detecting edges from the input image using a Sobel filter or the like, or otherwise, the determination of whether or not the predetermined image-quality condition is satisfied may be performed based on the ratio of high-frequency components by subjecting the input image to frequency analysis. Alternatively, for example, a configuration may be adopted such that the evaluation value calculation unit 204 determines whether or not an image defect quantity is greater than or equal to an amount satisfying the predetermined image-quality condition based on an image-defect evaluation value that is output using a machine learning model that receives an image as input and outputs an evaluation value (e.g., noise level) of image defects in the input image. Furthermore, for example, a configuration may be adopted such that the evaluation value calculation unit 204 performs the determination using a machine learning model that has been trained to provide output as to whether or not an image defect quantity in the input image is greater than or equal to an amount satisfying the predetermined image-quality condition. In such a manner, the image defects to be evaluated based on pixel values may be set as desired, and the threshold value to be used as the predetermined image-quality condition may be capable of being set by the user, as appropriate. Furthermore, in such a manner, the condition that a value obtained by evaluating the noise level in an image is greater than or equal to a predetermined threshold may be used as the predetermined image-quality condition, for example.

As described above, the image processing apparatus 100 according to the present embodiment can use a first quality-enhanced image in place of the input image in embodiment 1, and calculate evaluation values of other quality-enhanced images based on the first quality-enhanced image and the other quality-enhanced images. In the following, the first quality-enhanced image used in place of the input image is referred to as a “reference image”.

In step S604, the evaluation value calculation unit 204 selects the reference image from among the first quality-enhanced images. Here, for example, the evaluation value calculation unit 204 may select, as the reference image, a first quality-enhanced image for which it has been determined that the image-defect evaluation value (e.g., noise level) used in step S603 is the smallest, or a first quality-enhanced image selected based on user input. By selecting the reference image from among the first quality-enhanced images, the reference image can be selected from among images in which there is not much change in structural information from the input image and hallucinations (e.g., false details, artifacts) are unlikely to be produced as discussed above.

In step S605, based on the reference image and quality-enhanced images (other than the reference image), evaluation values of the quality-enhanced images are calculated. This processing can be executed similarly to step S303 in embodiment 1 with the exception that the reference image is used in place of the input image; redundant description is thus omitted. Furthermore, here, the input image is used as the reference image if it is determined in step S603 that the predetermined image-quality condition is not satisfied.

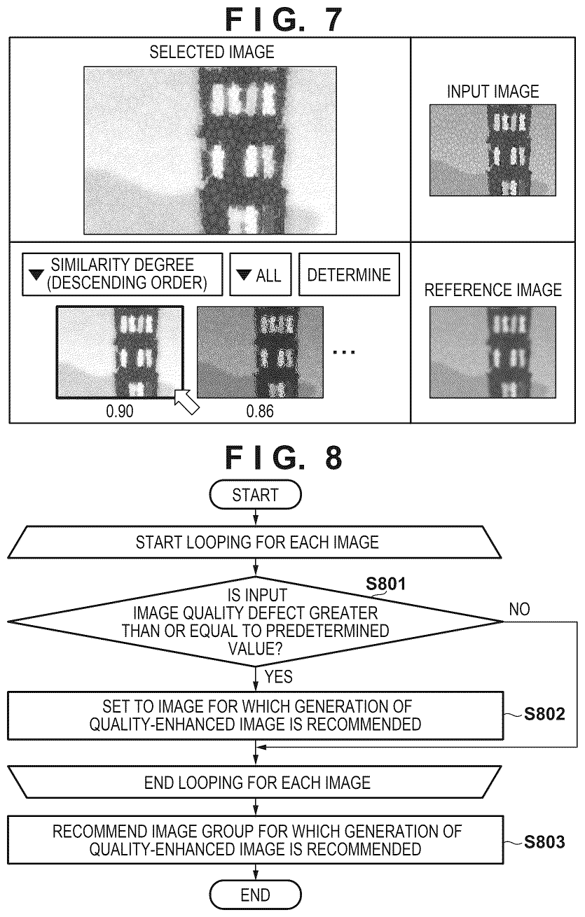

FIG. 7 is a diagram illustrating an example of display of the first quality-enhanced images and the second quality-enhanced images in a case in which evaluation values (similarity degrees) are calculated using the reference image in place of the input image. In FIG. 7, display is performed in a similar manner as in FIG. 4A in embodiment 1 with the exception that the reference image is additionally displayed; however, the first quality-enhanced images and the second quality-enhanced images may be displayed separately as illustrated in FIG. 4B.

According to such processing, evaluation values of other quality-enhanced images can be calculated using a first quality-enhanced image as the reference image if the input image satisfies the predetermined image-quality condition. Thus, if the input image includes a large amount of image defects, a reference image similar to the original image (reference image in which hallucinations (e.g., false details, artifacts), etc., are unlikely to be produced) is set after enhancing the image quality of such an input image, and display can be performed of quality-enhanced images similar to such a reference image. Accordingly, images having evaluation values close to an image obtained by removing or reducing image defects can be presented to the user.

### Embodiment 4

The image processing apparatus 100 according to embodiment 4 has the same configuration as that in embodiment 1 and can execute the same processing as that in embodiment 1; redundant description is thus omitted. Furthermore, the image processing apparatus 100 according to the present embodiment determines whether or not pixel values of a processing-target-candidate image (e.g., image stored in the data storage unit 205) satisfy a predetermined image-quality condition. Subsequently, if the predetermined image-quality condition is satisfied, the image processing apparatus 100 issues a notification (recommendation) that the execution of image-quality enhancement processing on the image is recommended.

In the following, description is provided of an example of such image processing performed by the image processing apparatus 100. FIG. 8 is a flowchart illustrating an example of determination processing executed by the image processing apparatus 100 according to the present embodiment to determine whether or not to issue a notification that the execution of image-quality enhancement processing on images is recommended. The processing illustrated in FIG. 8 is started, for example, at a predetermined timing when an image is not being captured, during execution of a sleep operation, during execution of charging, or a timing based on a start operation by the user, and the different types of processing are executed by the control unit 106.

First, the loop processing from step S801 to step S802 is started using, as the processing target, one of processing-target-candidate images (which is an image group stored in the data storage unit 205 here). In step S801, the evaluation value calculation unit 204 determines whether or not the pixel values of the processing-target image satisfy the predetermined image-quality condition. The determination processing performed in step S801 is basically the same as that performed in step S603; however, the threshold that is used may be varied from that in step S603. Processing advances to step S802 if the predetermined image-quality condition is satisfied. If the predetermined image-quality condition is not satisfied, processing advances to step S803 if all processing-target-candidate images have been set as the processing target; otherwise, an image that has not yet been set as the processing target is selected as the processing target, and processing then returns to step S801.

In step S802, the evaluation value calculation unit 204 sets the processing-target image as an image for which the execution of image-quality enhancement processing is recommended. Subsequently, the evaluation value calculation unit 204 advances processing to step S803 if all processing-target-candidate images have been set as the processing target; otherwise, the evaluation value calculation unit 204 selects an image that has not yet been set as the processing target as the processing target, and then returns processing to step S801.

In step S803, the image display unit 203 issues a notification regarding images set as images for which the execution of image-quality enhancement processing is recommended in step S802, whereafter the processing in FIG. 8 ends. The notification here may be a notification indicating that there are images for which the execution of image-quality enhancement processing is recommended, a notification indicating the number of images for which the execution of image-quality enhancement processing is recommended, or a notification displaying images for which the execution of image-quality enhancement processing is recommended.

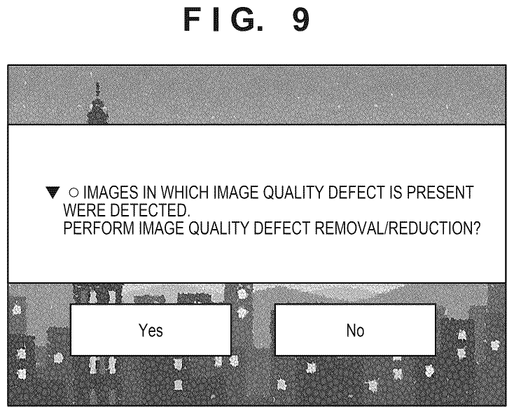

FIG. 9 is a diagram illustrating an example of a notification displayed by the image display unit 203. In FIG. 9, as the notification, the number of images for which the execution of image-quality enhancement processing is recommended, and a UI allowing the user to select whether or not to check the images are displayed.

According to such processing, a notification that the execution of image-quality enhancement processing is recommended can be provided for images of which pixel values satisfy the predetermined image-quality condition. Accordingly, the time and effort that the user has to spend visually checking images can be reduced.

### OTHER EMBODIMENTS

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-220251, filed Dec. 16, 2024, which is hereby incorporated by reference herein in its entirety.

What is claimed is:

1. An image processing apparatus comprising:
a first generating unit configured to generate a second image having a higher image quality than a first image by performing first image-quality enhancement processing;
a second generating unit configured to generate a third image having a higher image quality than the first image by performing second image-quality enhancement processing that is different from the first image-quality enhancement processing and has a generation condition specified as text; and
a display controlling unit configured to perform display control for displaying at least one of the second image and the third image.

2. The image processing apparatus according to claim 1, further comprising:
a calculating unit configured to calculate a first evaluation value of the second image for evaluating smallness of image change in the first image-quality enhancement processing, and a second evaluation value of the third image for evaluating smallness of image change in the second image-quality enhancement processing,
wherein the display controlling unit performs display control for displaying at least one of the second image and the third image based on the first evaluation value and the second evaluation value.

3. The image processing apparatus according to claim 2,
wherein the first evaluation value is a similarity degree between the first image and the second image, and the second evaluation value is a similarity degree between the first image and the third image.

4. The image processing apparatus according to claim 2,
wherein the display controlling unit performs display control such that the second image and the third image are displayed in an order that is based on the first evaluation value and the second evaluation value.

5. The image processing apparatus according to claim 4,
wherein the display controlling unit performs display control such that the second image and the third image are displayed in a descending order that is based on the first evaluation value and the second evaluation value.

6. The image processing apparatus according to claim 2,
wherein the display controlling unit performs display control such that the second image and the third image are displayed without being individually identified.

7. The image processing apparatus according to claim 2,
wherein the display controlling unit performs display control such that the second image and the third image are displayed so as to be individually identified.

8. The image processing apparatus according to claim 2,
wherein the display controlling unit performs display control such that the second image is displayed in a case where the first evaluation value satisfies a predetermined condition, and the third image is displayed in a case where the first evaluation value does not satisfy the predetermined condition.

9. The image processing apparatus according to claim 8,
wherein the second generating unit generates the third image in a case where the first evaluation value does not satisfy the predetermined condition.

10. The image processing apparatus according to claim 8,
wherein the first evaluation value is a similarity degree between the first image and the second image, and the predetermined condition is that the similarity degree is greater than or equal to a predetermined threshold.

11. The image processing apparatus according to claim 2, further comprising:
a determining unit configured to determine whether or not the first image satisfies a predetermined image-quality condition; and
a selecting unit configured to, in a case where the first image satisfies the predetermined image-quality condition, select one image from among a group of images generated by the first image-quality enhancement processing as a reference image,
wherein if the first image satisfies the predetermined image-quality condition, the calculating unit calculates the first evaluation value as a similarity degree between the reference image and the second image, and calculates the second evaluation value as a similarity degree between the reference image and the third image, and
if the first image does not satisfy the predetermined image-quality condition, the calculating unit calculates the first evaluation value as a similarity degree between the first image and the second image, and calculates the second evaluation value as a similarity degree between the first image and the third image.

12. The image processing apparatus according to claim 11,
wherein the predetermined image-quality condition is that an evaluation value obtained by evaluating a noise level in the first image is greater than or equal to a predetermined threshold.

13. The image processing apparatus according to claim 11,
wherein the selecting unit selects, as the reference image, an image having a smallest noise-level evaluation value from among the group of images generated by the first image-quality enhancement processing.

14. The image processing apparatus according to claim 1,
wherein the first image-quality enhancement processing is processing in which the second image is generated by correcting the first image, and the second image-quality enhancement processing is processing in which the third image is generated without correcting the first image.

15. The image processing apparatus according to claim 14,
wherein the first image-quality enhancement processing is processing in which hallucinations are less frequently observed after processing compared to the second image-quality enhancement processing.

16. The image processing apparatus according to claim 1,
wherein the first image-quality enhancement processing is processing in which a patch-size image is input and processed to enhance image quality, and the second image-quality enhancement processing is processing in which an image that is larger than the patch-size image and that includes the patch-size image is input to enhance image quality.

17. The image processing apparatus according to claim 1, further comprising:
a determining unit configured to determine whether or not a fourth image satisfies a predetermined image-quality condition; and
a notifying unit configured to, in a case where the fourth image satisfies the predetermined image-quality condition, provide a notification that execution of image-quality enhancement processing on the fourth image is recommended.

18. An image processing method comprising:
generating a second image having a higher image quality than a first image by performing first image-quality enhancement processing;
generating a third image having a higher image quality than the first image by performing second image-quality enhancement processing that is different from the first image-quality enhancement processing and has a generation condition specified as text; and
performing display control for displaying at least one of the second image and the third image.

19. A non-transitory computer-readable storage medium configured to store a computer program comprising instructions for executing following processes:
generating a second image having a higher image quality than a first image by performing first image-quality enhancement processing;
generating a third image having a higher image quality than the first image by performing second image-quality enhancement processing that is different from the first image-quality enhancement processing and has a generation condition specified as text; and
performing display control for displaying at least one of the second image and the third image.
